(19) United States
(12) Patent Application Publication
(10) Pub. No.: US 2016/0117446 A1
(43) Pub. Date: Apr. 28, 2016

(54) Generating an Ambulatory Surgical Center (ASC) Electronic Medical Record (EMR)

(71) Applicant: Universal Research Solutions, LLC, Columbia, MO (US)

(72) Inventors: Ali Adel Hussam, Columbia, MO (US); Nathan Bleigh, Kansas City, MO (US)

(21) Appl. No.: 14/522,303

(22) Filed: Oct. 23, 2014

(51) Int. Cl. G06F 19/00

(52) U.S. Cl. CPC G06F 19/322; G06F 19/3425

(57) ABSTRACT

A computer-implemented method comprises: establishing, over a private network in an ambulatory surgical center (ASC), a communication channel between a medical device in the ASC and an ASC integration system that is connected to the Internet; receiving, by the established communication channel over the private network, real-time medical information from the medical device, during performance of a surgical procedure at the ASC; applying one or more notification rules to the received real-time medical information to detect the occurrence of a triggering event; determining, from the one or more notification rules, one or more entities to contact regarding the triggering event, with the one or more entities having one or more devices that are unconnected to the private network; and transmitting, by the ASC system over the Internet, one or more notification messages to the one or more devices that are unconnected to the private network.

### BACKGROUND

Medical forms are used to collect data and information regarding a patient's symptoms and conditions.

### SUMMARY

In one implementation, a computer-implemented method comprises: establishing, over a private network in an ambulatory surgical center (ASC), a communication channel between a medical device in the ASC and an ASC integration system that is connected to the Internet, with the medical device being restricted to communication over the private network; receiving, by the established communication channel over the private network, real-time medical information from the medical device, during performance of a surgical procedure at the ASC; applying one or more notification rules to the received real-time medical information to detect the occurrence of a triggering event; determining, from the one or more notification rules, one or more entities to contact regarding the triggering event, with the one or more entities having one or more devices that are unconnected to the private network; and transmitting, by the ASC system over the Internet, one or more notification messages to the one or more devices that are unconnected to the private network. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The actions include receiving, from an external device, a request to schedule the surgical procedure with the ASC; receiving, from the external device, a Consolidated Clinical Document Architecture (CCDA) record that includes first medical information for a patient for whom the surgical procedure is being scheduled; receiving, from another external device, second medical information for the patient; detecting a conflict between the first medical information and the second medical information; and prompting a user for information to resolve the conflict. The actions include transforming the first and second medical information into an ASC EMR by generating a data record that includes the second medical information and attaching the generated data record to the first medical record; executing a rules engine against contents of ASC EMRs to determine whether the ASC EMRs comply with one or more governmental regulations for ASC EMRs; and receiving, from an electronic device in an operating room over a private network, real-time operating room information; and adding the real-time operating room information to the ASC EMR. The second medical information is retrieved from a medical instrument system that is configured to administer one or medical instruments and collect results of those medical instruments. The actions include generating information indicative of an appointment to perform the surgical procedure; and defining, for the appointment, one or more roles of service providers in the ASC with regards to the surgical procedure, with a role specifying one or more types of information that a particular type of service provider is responsible for inputting into the ASC system. The actions include receiving information that is input to the system from a service provider assigned to a specific role, with the received information including a personal identification number; and confirming that the personal identification number matches an authorized personal identification number of a user who is authorized to perform the role and to input a type of information to be completed by an entity in the assigned role. The actions include automatically triaging, by the ASC system, intake of a patient for whom the surgical procedure is performed by performing operations comprising: generating data for a graphical user interface that displays consent forms and medical information for the patient, with the medical information being collected from a plurality of different data sources. The actions include synchronizing, by the ASC system, the real-time medical information with other medical information included in a data repository of the ASC system. Synchronizing comprises: updating a data record in the data repository with the real-time medical information.

All or part of the foregoing may be implemented as a computer program product including instructions that are stored on one or more non-transitory machine-readable storage media and/or one or more machine-readable hardware storage devices that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIGS. 1-7 and 9-13 are screen images of graphical user interfaces generated by a system for generating an ASC EMR.

FIGS. 8, 16 and 17 are flow charts of example processes for generating an ASC EMR.

FIG. 14 is a diagram of a system for generating an ASC EMR.

FIG. 15 is a block diagram of components of a system for generating an ASC EMR.

Like reference symbols in the various drawings indicate like elements.

### DETAILED DESCRIPTION

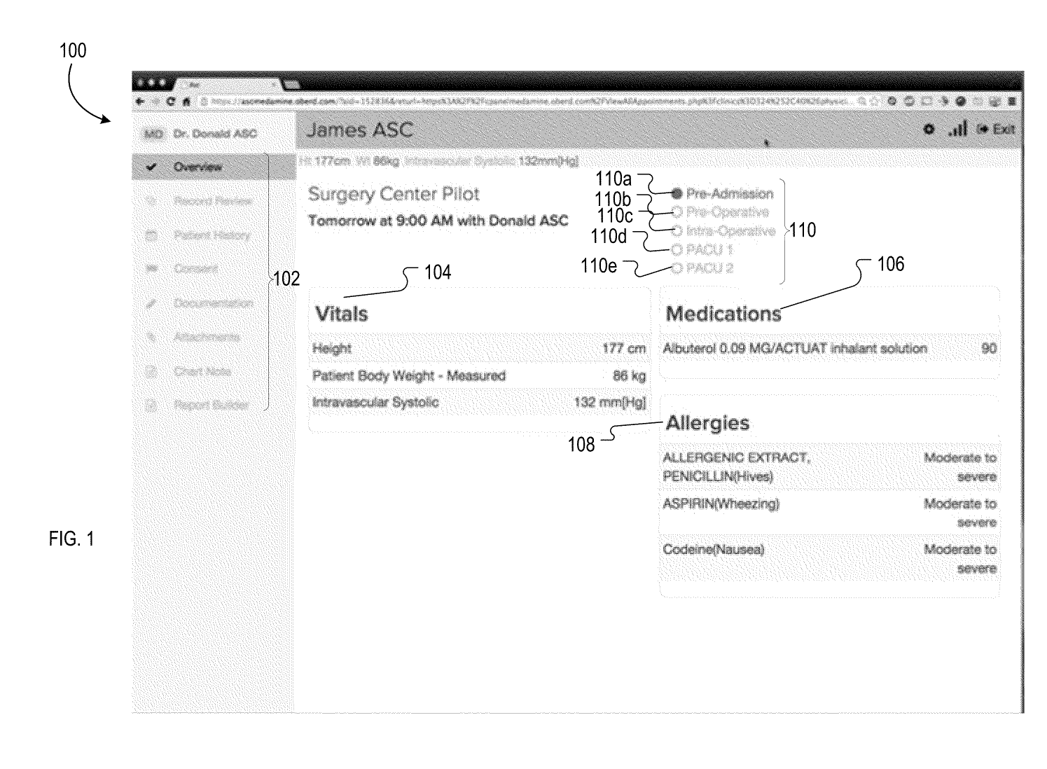

Referring to FIG. 1, graphical user interface 100 displays information pertaining to a patient of an ambulatory surgical center (ASC). Generally, ASCs are medical facilities that specialize in elective same-day or outpatient surgical procedures. A system consistent with this disclosure aggregates medical information for use in an ASC, as well as facilitating ASC operation. Graphical user interface 100 includes menu 102 to enable a view to access various types of information for the ASC, including, medical records, a patient history, consent form, documentation, attachments, chart notes and a report builder. Graphical user interface 100 also includes portions 104, 106, 108 to provide the viewer with vital information, medication information and allergy information, respectively. Graphical user interface 100 also includes stage section 110 with controls 110a-110e. Selection of one of controls 110a-110e causes portions 104, 106, 108 to be updated to display information that associated with the particular stage (e.g., stage of a medical procedure) for the selected control. For example, when a user selects controls 110a, portions 104, 106, 108 are updated to display vital information, medication information and allergy information, respectively, as of pre-admission.

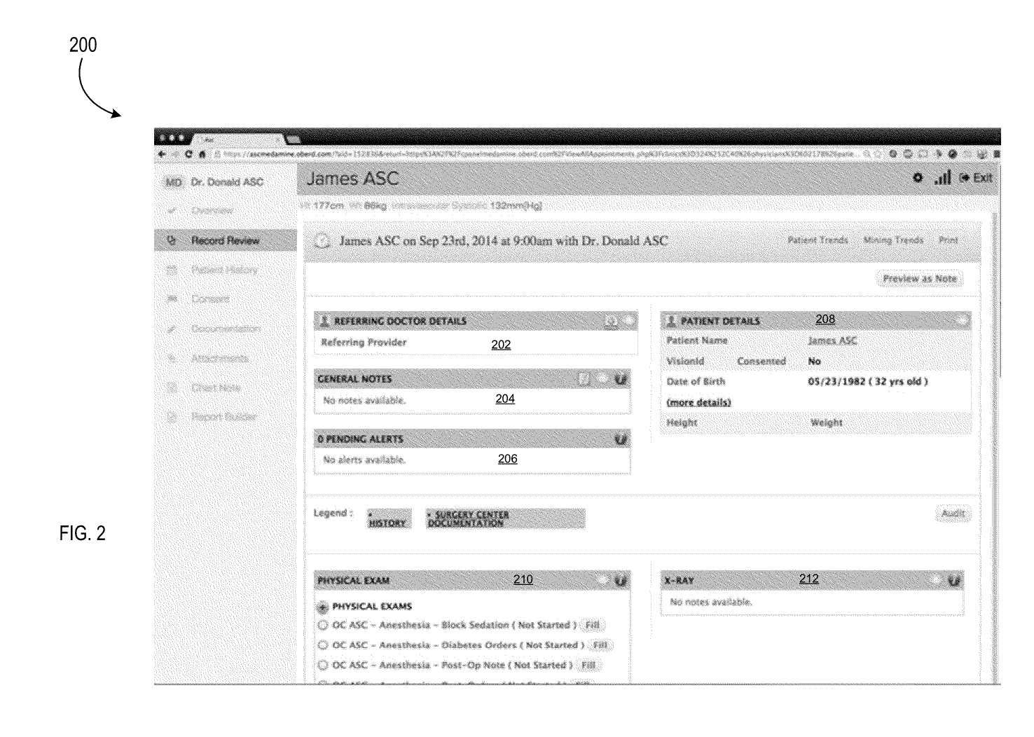

Referring to FIG. 2, graphical user interface 200 displays details of a medical record, e.g., for a patient of the ASC. Graphical user interface 200 includes portions 202, 204, 206, 208, 210, 212 to display information indicative of referring doctor details, general notes, pending alerts, patient details, physical exams, and X-rays, respectively. In an example, the system (that generates graphical user interface 200) receives the medical record information from a Consolidated Clinical Document Architecture (CCDA) document that is sent from a CCDA system. In this example, physical exam portion 210 displays information indicative of which physical exams the patient has already had performed. Portion 210 allows for a manual override by enabling a user to select one of the physical exam types, e.g., to specify that the user has had that type of physical exam.

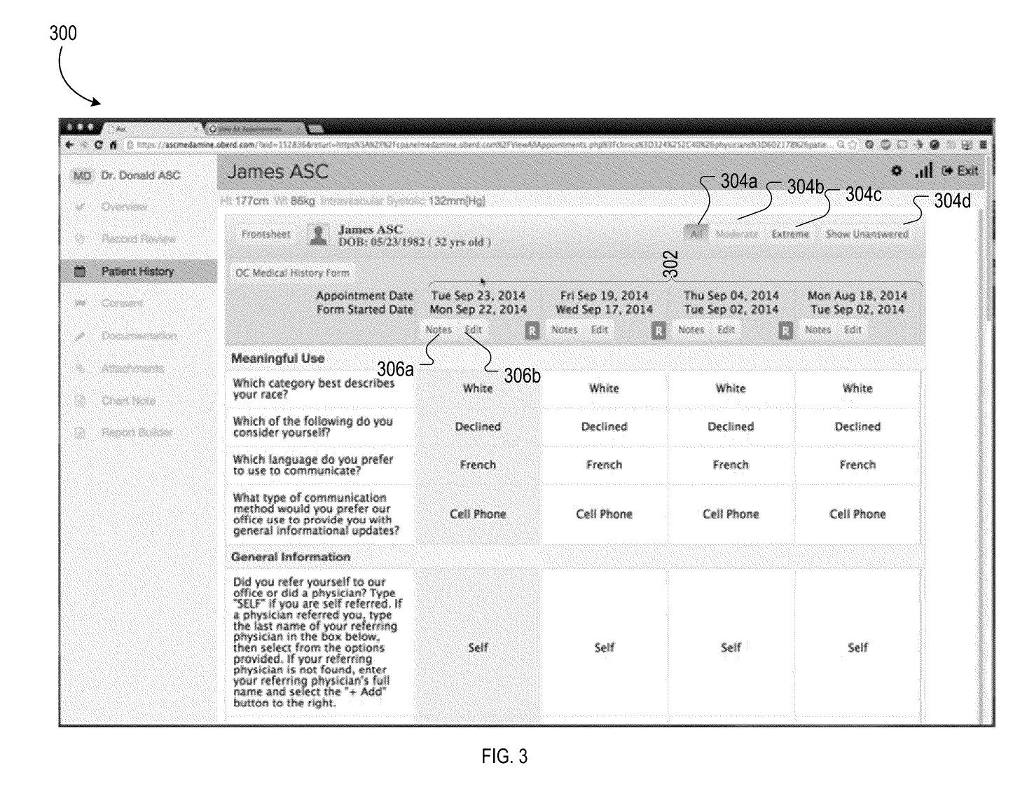

Referring to FIG. 3, graphical user interface 300 displays patient history information, e.g., using information that is collected from the CCDA system, information that is collected from the ASC system described herein, or that is collected from a medical instrument system (for sending medical questionnaires and instruments to patient. Graphical user interface 300 includes timeline 302 to display discrete intervals at which the questions of a particular medical instrument are asked to a patient, and corresponding responses. Graphical user interface 300 includes controls 304a, 304b, 304c and 304d to enable filtering of the patient history. For example, control 304a enables a user to view all of the answers. Control 304b enables a user to view “moderate” answers to questions, e.g., those answers that exceed a specified threshold that represents a moderate nature. Control 304c enables a user to view extreme answers to questions, e.g., those answers that exceed a specified threshold that represents an extreme nature. Control 304d enables a user to view unanswered questions. Graphical user interface 300 also includes controls 306a, 306b to able a user to add notes to the answers and to edit answers to questions, respectively.

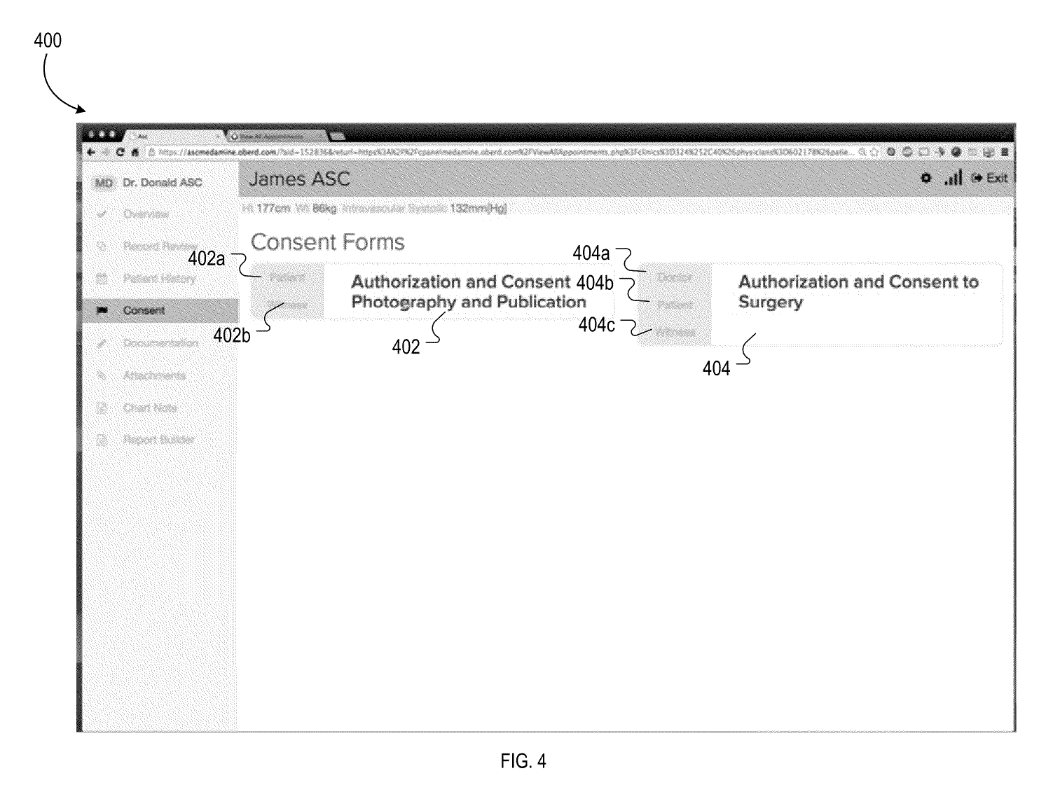

Referring to FIG. 4, graphical user interface 400 displays various consent forms to a viewer. For example, graphical user interface 400 displays consent form portions 402, 404. Consent form portions 402, 404 each display information specifying individuals who are required to sign the consent form. For example, consent form portion 402 includes required individual information 402a, 402b specifying that a patient and a witness are each required to sign off on the consent form. Consent form portion 404 includes required individual information 404a, 404b, 404c specifying that a doctor, a patient and a witness are each required to sign off on the consent form. Selection of portions 402, 404 causes a display of the appropriate consent form.

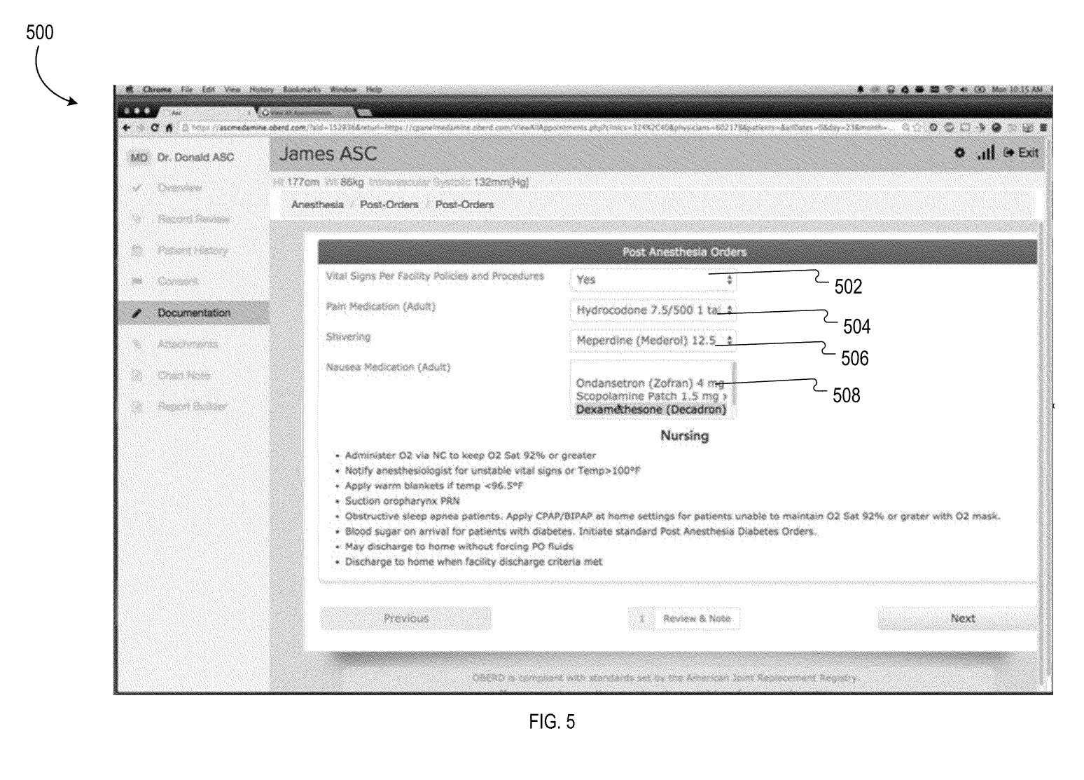

Referring to FIG. 5, graphical user interface 500 allows a user to input various documentation, e.g., following a medical procedure. Such procedure can include an anesthesia procedure. Graphical user interface 500 includes fields 502, 504, 506, 508 for the input of this documentation information. In an example, fields 502, 504, 506, 508 are auto-populated, e.g., based on information received in a CCDA document and/or other collected information. The values of fields 502, 504, 506, 508 can also be manually overwritten, e.g., to be updated.

In an example, the system synchronizes the data in real-time from multiple data sources. In this example, some of the data may be in conflict, e.g., the same data field may have differing, conflicting values. In this example, the system performs conflict resolution, e.g., based on date and time in which the most recent data values override less recent data values. Following conflict resolution, an alert is displayed (via the system) that shows that various data values are modified.

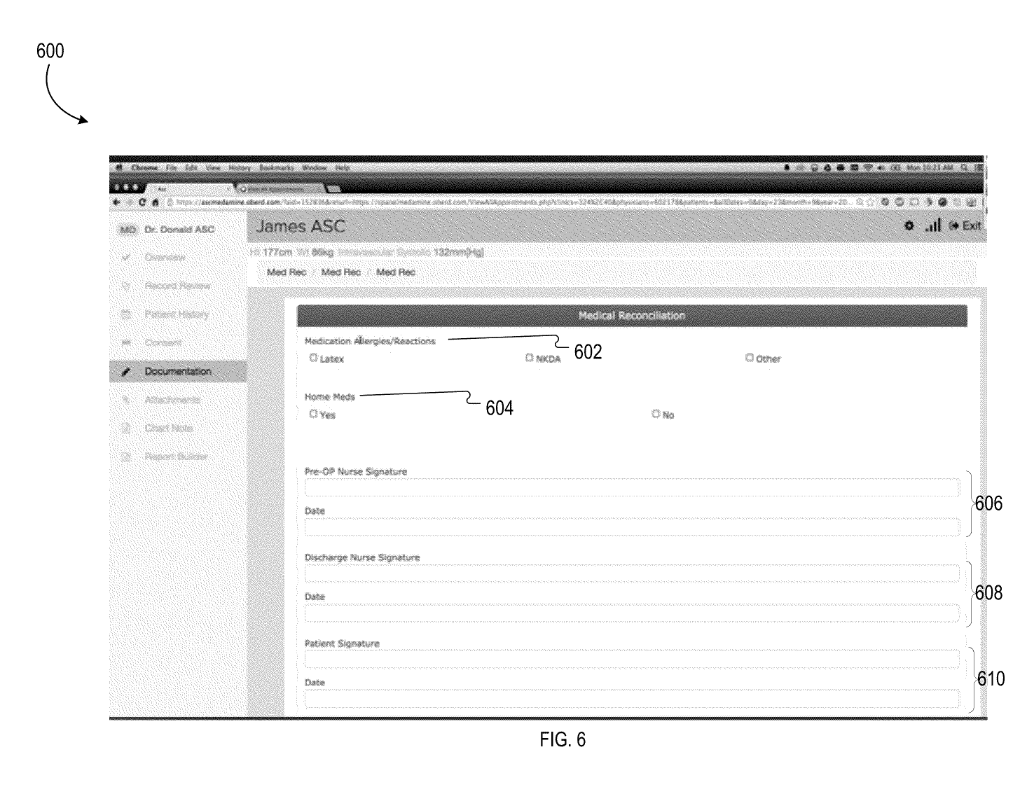

Referring to FIG. 6, graphical user interface 600 provides for medical reconciliation (e.g., based on detection of a conflict among values in data fields). After resolution, there is an alert that shows that the page has been modified. Graphical user interface 600 includes portions 602, 604 that specify which types of medical information need to be reconciled. For example, portion 602 specifies that medication allergies/reactions need reconciliation, e.g., by prompting the user to specify whether there is a medication reaction/allergy to latex or other materials. For example, a CCDA record may indicate that a patient does not have an allergy to latex. Another medical record may indicate that the patient does have an allergy reaction to latex. Accordingly, there is a conflict regarding whether the patient has an allergic reaction to latex and the patient or another user is prompted to resolve the conflict, e.g., by providing reconciliation information into graphical user interface 600.

In this example, portion 604 prompts the user to reconcile whether a patient is taking home medications (e.g., via a yes/no field). Following the input of the reconciliation information, graphical user interface 600 prompts various entities for their signature, e.g., to input the reconciliation information. Once the reconciliation information is input into the system, the reconciliation information overrides all other conflicting information for a particular field.

In this example, portions 606, 608, 610 require signatures from various entities (i.e., a pre-OP nurse, a discharge nurse and a patient), prior to entering the reconciliation information into the system. These various signatures are required to ensure the authenticity and validity of the reconciliation information that is being input into the system.

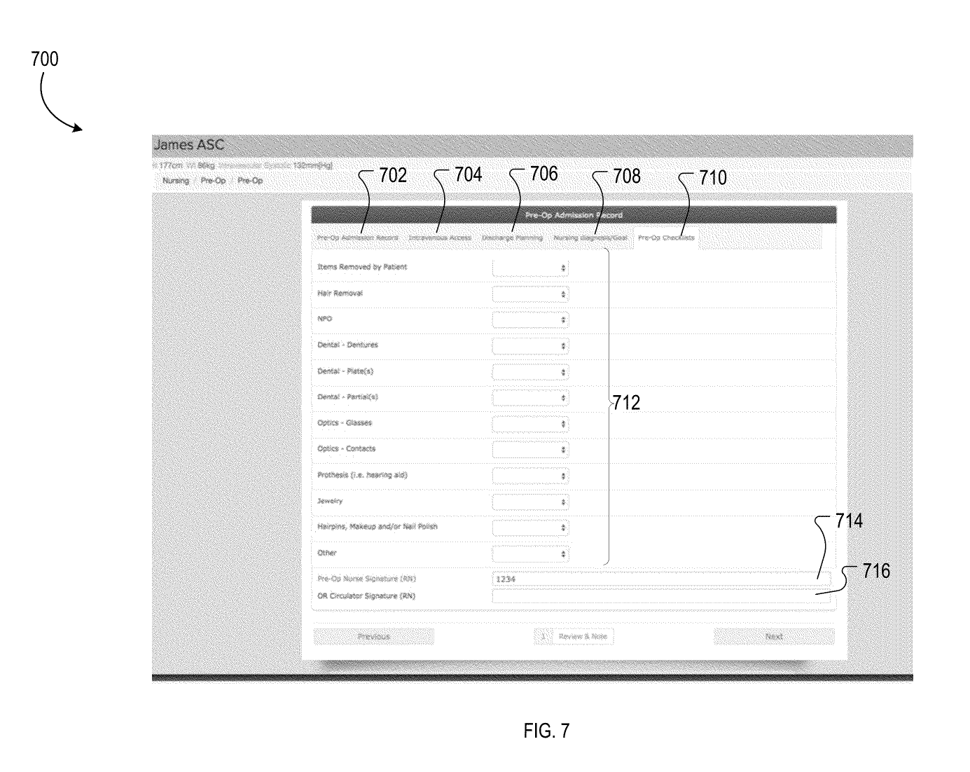

Referring to FIG. 7, the ASC system provides for per appointment roles, e.g., for the various types of service providers. In an example, for a particular appointment, the system sets up various “roles”—assignments to be completed by pre-specified types of service providers. In this example, for a particular appointment and/or type of procedure, various service providers will have various, specified types of roles, e.g., a role of filling out a pre-operative admission record, a role of administering intravenous access, a role of planning discharge, a role of determining nursing and diagnosis roles, and a role of filling out a preoperative checklist. In this example, a particular type of service provider is assigned to a particular role. On the backend, a database record (in a database) in updated with information specifying which type of service provider is assigned to the various roles. The information specifying the assigned type of service provider is linked to other information specifying the names of service providers of the specified type, as shown in the below Table 1.

TABLE 1

| | Type | |
|---|---|---|
| Role | of Service Provider | Valid PINS |
| Complete Pre-Operative | Pre-Op Nurse; | Pre-Op Nurse Signature |
| Checklist | OR Circulator | (1234, 1245) |
| | | OR Circulator Signature |
| | | (1244, 1256) |

As shown in the above Table 1, an example data base record specifies a role of completing a pre-operative checklist. The database record also specifies that two types of service providers (e.g., a pre-op nurse and an operating room (OR) circulator) are authorized to fill out and complete the pre-op checklist. The database record also specifies valid personal identification numbers (PINS) for the service providers that are authorized to complete the role, e.g., by filling out the pre-op checklist. In order to enter and save the information entered into a pre-op checklist, a PIN number is entered. The system verifies if the entered PIN matches one of the pre-authorized pins that are associated with the role, e.g., as shown in the above Table 1.

In the example of FIG. 7, graphical user interface 700 includes role information 702, 704, 706, 708, 710 that is indicative of the various roles that a service provider may provide during an appointment. In an example, role information 702 specifies types of information that is to be entered by a service provider fulfilling a specific role. For example, role information 710 specifies that a pre-operative checklist is to be completed by a pre-operative nurse and an OR circulator. Role information 710 includes fields 712 for input and/or selection of required information. Upon completion of fields 712, the user completing fields 712 enters his/her signature (e.g., an assigned PIN). In this example, only pre-op nurses and OR circulators may enter information into fields 712. Graphical user interface 700 also includes PIN fields 714, 716 for entry of PINS of service providers of the authorized type. Prior to saving the information entered into fields 712, the system verifies that the PINS entered into PIN fields 714, 716 matches the valid pins specified in the data record, e.g., as shown in the above Table 1, thereby verifying that only authorized personally in their assigned roles are completing the pre-operative checklist.

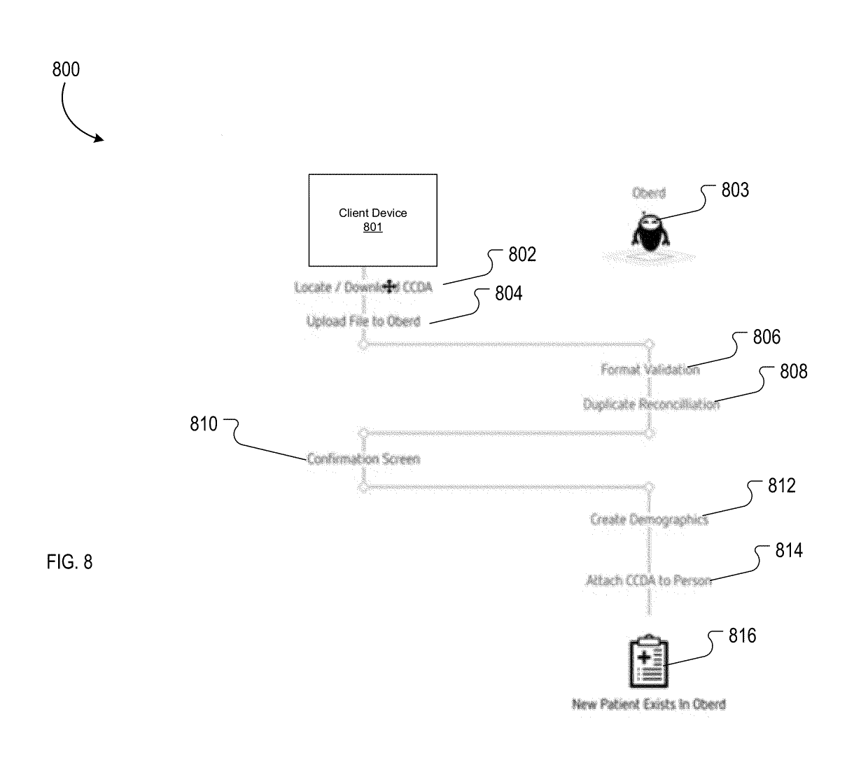

Referring to FIG. 8, process 800 is performed to integrate a CCDA record with an ASC system 803 described herein. In operation, a client device 801 accesses and downloads (802) a CCDA record, e.g., from an external database, from a hospital, and so forth. The client device 801 uploads (804) the CCDA record to the ASC system 803. The ASC system 803 validates (806) the format of the CCDA record, e.g., to ensure that the fields in the CCDA record are accessible and/or are formatted in accordance with predefined standards. The ASC system 803 duplicates (808) the CCDA record for storing in a database of the ASC system 803 and displays (810) a confirmation screen to notify the user of the duplication. In an example, the duplicated record is a new record for the ASC system. The ASC system 803 creates (812) demographic information for the newly created record, e.g., using responses to questions in other medical instruments that the ASC system collects or otherwise has access to. In an example, the ASC system 803 identifies medical questionnaires or instruments that are completed by a particular patient, based on patient name, a social security number or other identifying information. The ASC system 803 identifies a match between the particular patient and a patient identified in a CCDA record based on name matching or based on matching the other identifying information included in the CCDA record and the medical questionnaire. Based on the matched records, the ASC system 803 attaches the CCDA document to the patient by generating a database pointer between the CCDA record and the other collected records and instruments for the patient. Following linking of the CCDA record to the other records and instruments, the patient exists in the ASC system (e.g., the patient is represented by one or more database records in the ASC system).

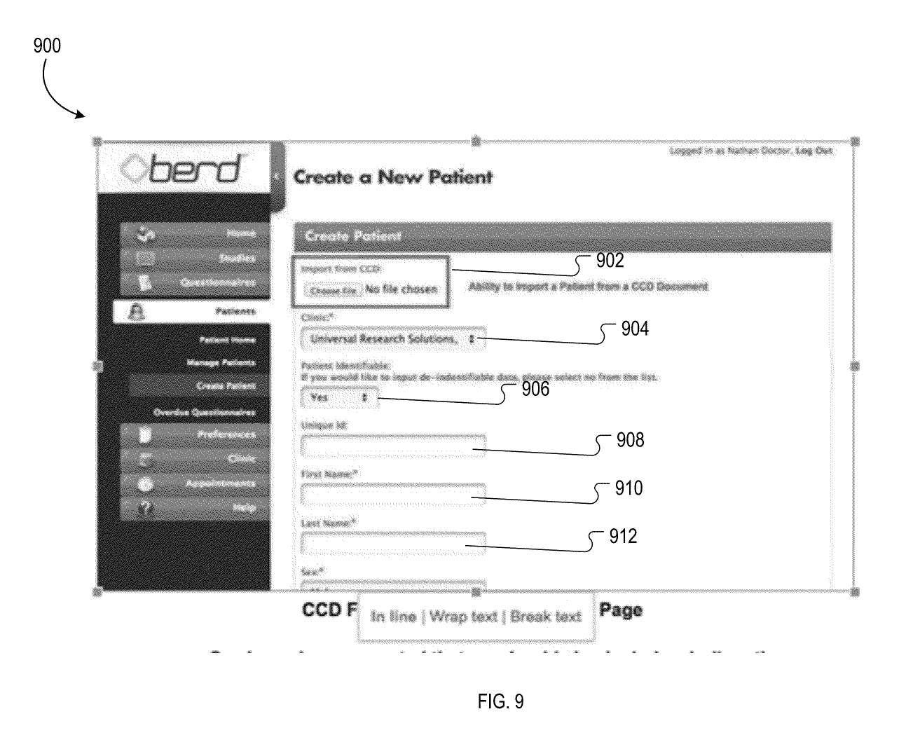

Referring to FIG. 9, graphical user interface 900 allows for importation of patient data, e.g., via a CCDA document. In this example, graphical user interface 900 is displayed on a client device that is configured for integration with one or more external systems. In this example, the client device is a terminal of the the ASC system. Graphical user interface 900 includes clinic field 904 for user selection of one or more clinics that are pre-configured for communication with the client device. Graphical user interface 900 also includes file control 902, for the user to select which CCDA file they want to import from the external system.

Graphical user interface 900 also includes patient identifiable control 906 for the user to specify whether the user wants to import identifiable patient data or de-identifiable patient data. If the user wants to input de-identifiable patient data, graphical user interface 900 includes control 908 for the input of a user ID that may be used to identify the patient, in lieu of other identifying information. In this example, the other database records that are already collected by the ASC system also include the patient ID, e.g., thereby enabling the ASC system to match the CCDA record with other records.

Graphical user interface 900 also includes name fields 910, 912 for entry of first and last name information, respectively. In this example, the first and last name information is used for integrating the CCDA document with other documents that are stored in or otherwise accessible by the ASC system, e.g., based on matching of names among the records.

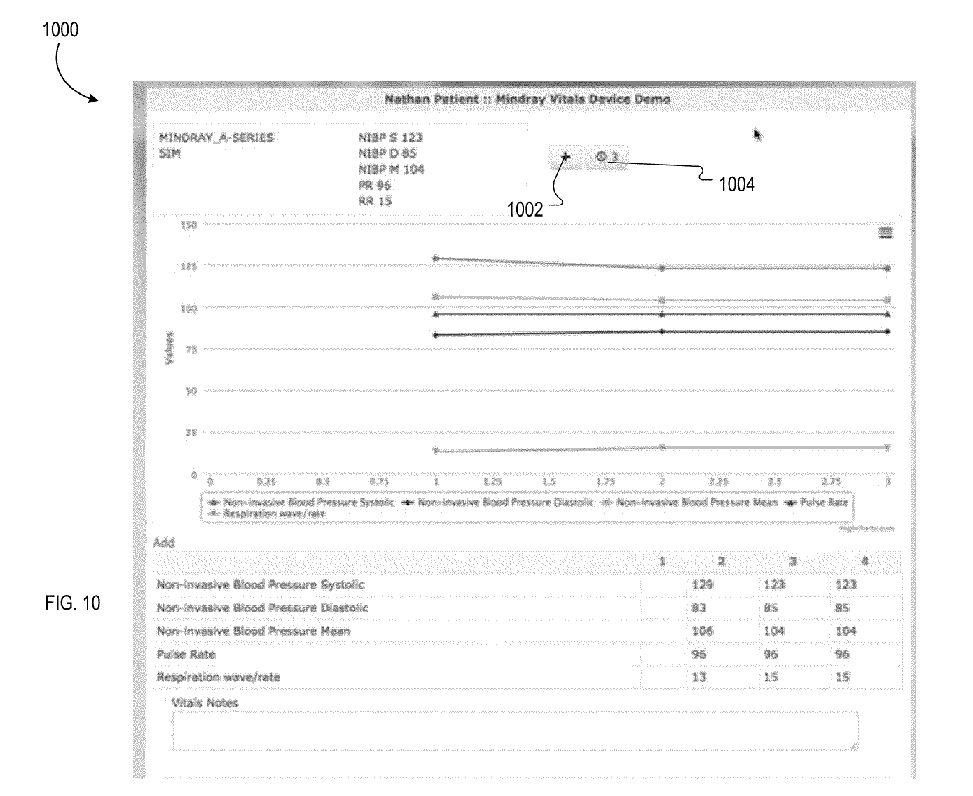

Referring to FIG. 10, graphical user interface 1000 displays various types of real-time vitals information over a period of time, e.g., based on the real-time monitoring of data. In this example, graphical user interface 1000 includes control 1002, selection of which causes the system to re-take a reading of the relevant vital information and to update the graph accordingly. In this example, a user get set a threshold for a type of information (e.g., that is being charted). When a value for the type of information exceeds the threshold, the system is configured to display an alert for the user. Graphical user interface 1000 also includes control 1004 that represents a timer that specifies how frequently data is being collected and how frequently the graph displayed in FIG. 10 is being updated.

In an example, an emergency room does not have Internet access, for security and confidentiality reasons. In this example, a virtual private network (VPN) is established between the ASC system and the monitoring devices in the emergency room, e.g., to enable the real time transmission of health date from the emergency room devices to the ASC system. In this example, the ASC system removes identifiable information it receives from the emergency room device and stored this de-identified information, e.g., in the cloud. The ASC system also may remove the identifying information, e.g., prior to presentation in a graph format.

In an example, a user (e.g., a patient) can set permissions for when/how to receive alerts. For example, a user may specify that he/she only wants to receive alerts to a mobile device, or only wants to receive alerts that are authenticated, and so forth.

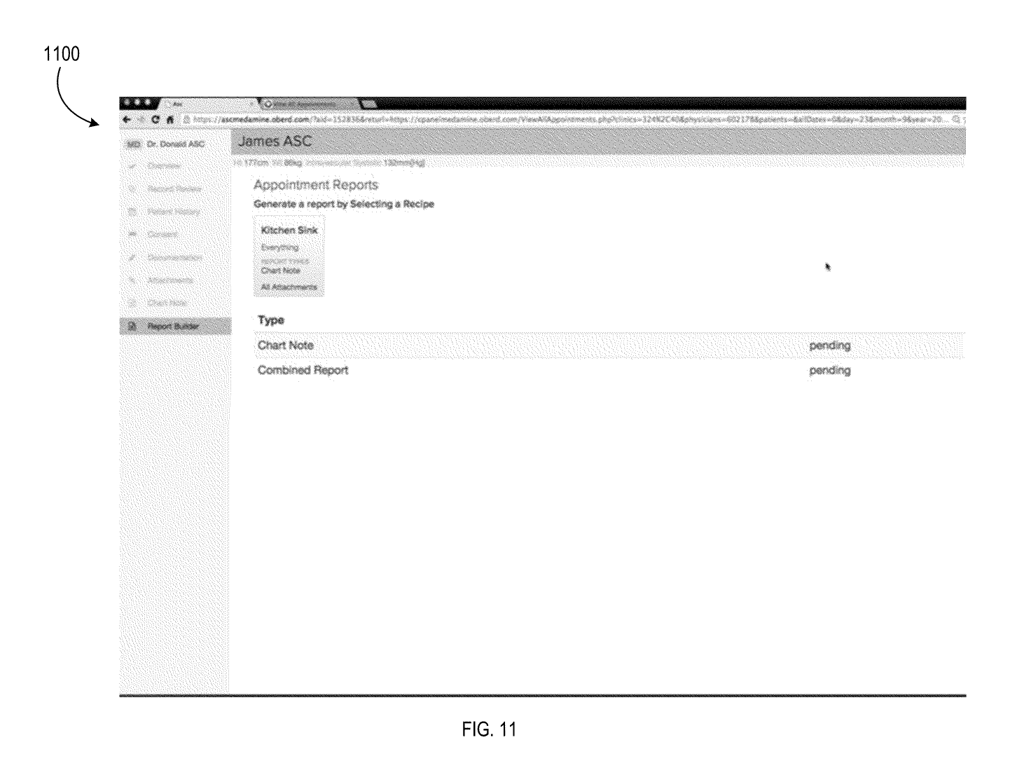

Referring to FIG. 11, graphical user interface 1100 enables a user to combine files to generate a report that combines information from various different sources. For example, a user can select to generate a combined report from a chart note (e.g., a medical note) and a medical outcomes note (e.g., information that specifies the outcome of one or more medical procedures).

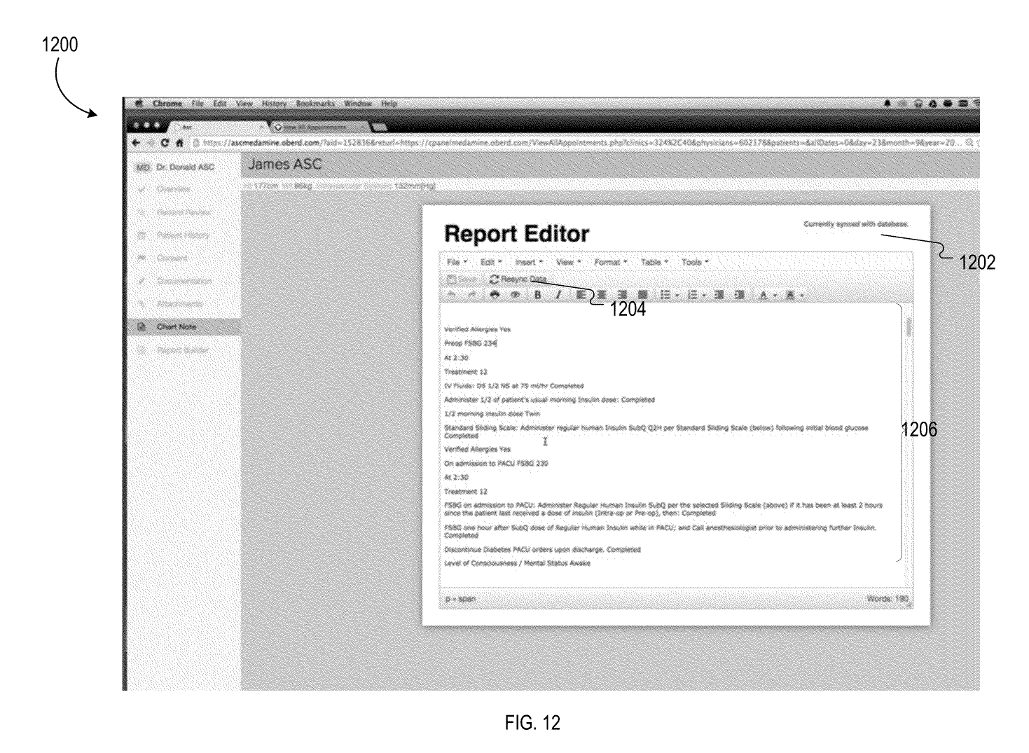

Referring to FIG. 12, graphical user interface 1200 displays a report editor that is used to edit and/or update a medical report and medical summary for a patient. The medical report is automatically generated by the ASC system and can be manually edited, e.g., by editing the text displayed in text box 1206. In an example, the report is automatically updated as the ASC system receives updated medical information, e.g., in real-time from emergency room monitoring devices, from CCDA documents and so forth. Graphical user interface 1200 displays synch information 1202 specifying whether the information displayed in the report is up-to-date and synched with the information that is in the database. Graphical user interface 1200 also displays synch control 1204, select of which causes the report to be re-synched with the database, e.g., to be updated with new information from the database.

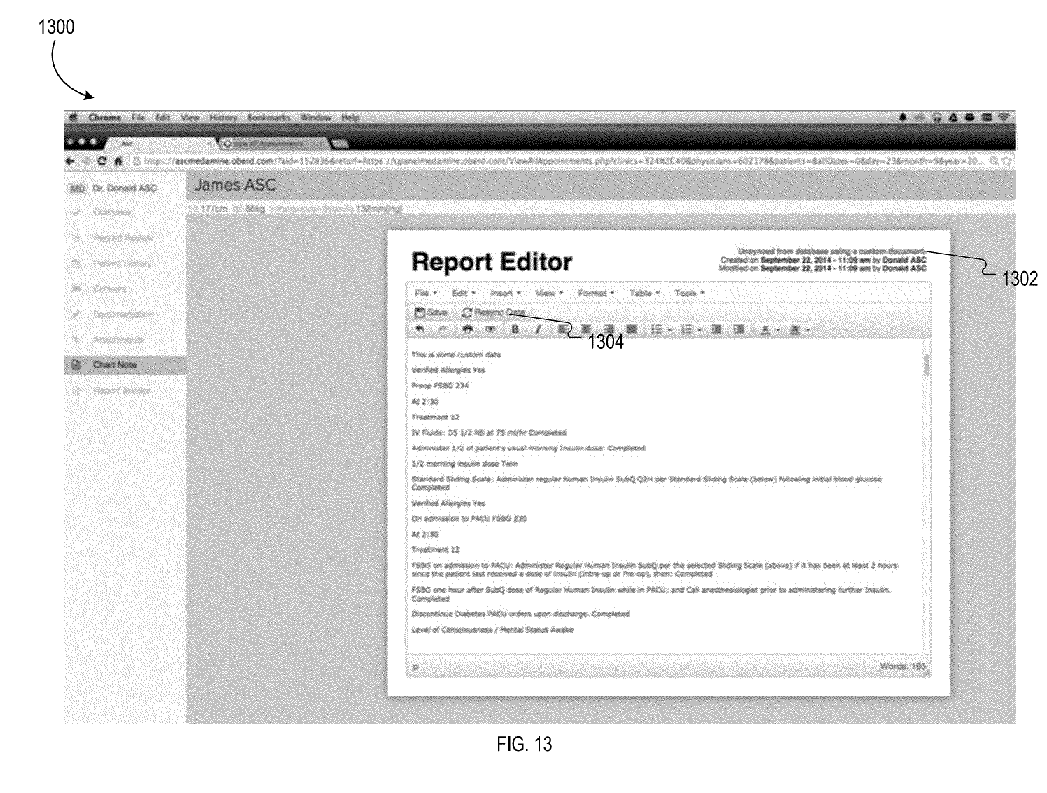

Referring to FIG. 13, graphical user interface 1300 displays another example of the report editor. In this example, the information displayed in the report edit in unsynched with the database, as shown by information 1302. There are various ways in which information can be unsynched with a database. In some examples, a user manually edits the report displayed in graphical user interface 1300, thereby causing the displayed report to be unsyched with the database. In this example, the user selects control 1304 to cause the report to be synched with the database, e.g., by updating the database with the information that is edited in the report. In another example, the report is unsynched with the database when that database is updated with information and that information is not yet displayed in the report. In this example, selection of control 1304 causes the report to be updated with the information that is saved in the database.

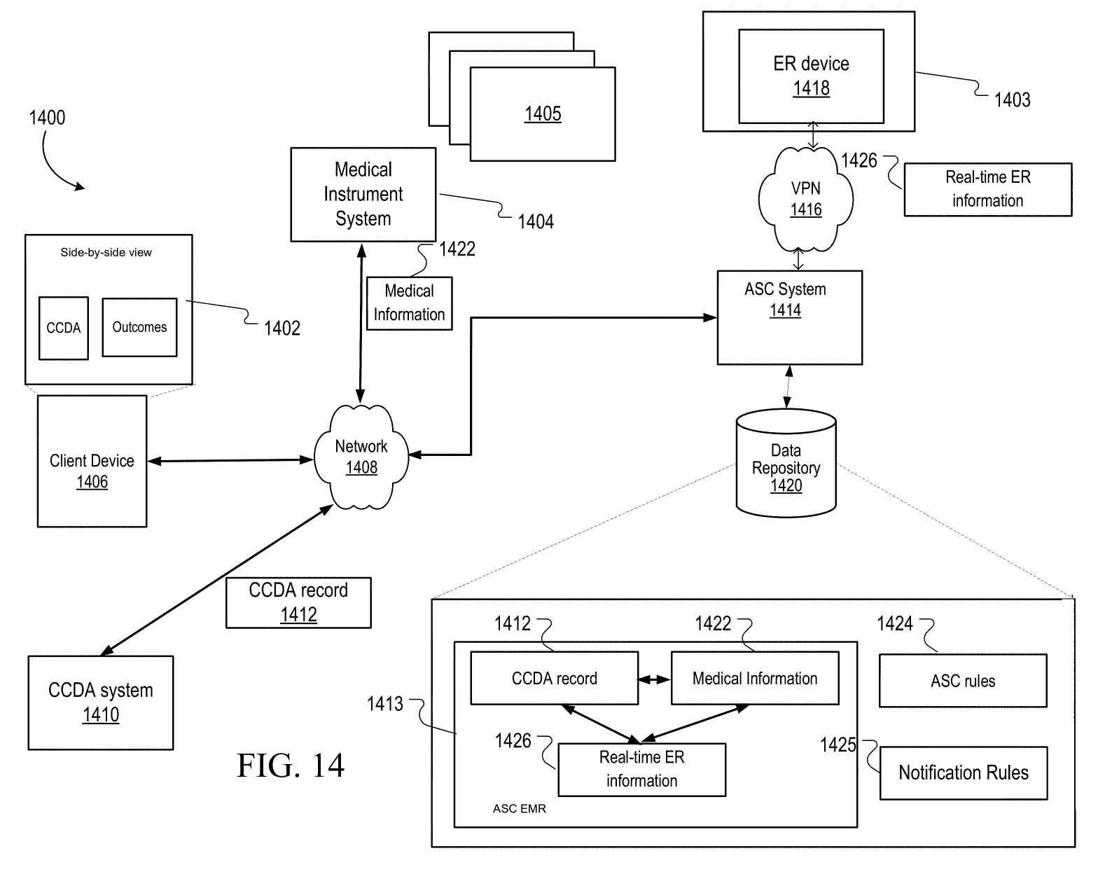

Referring to FIG. 14, networked environment 1400 allows for integration of propriety medical information (e.g., answers to medical instruments and questionnaires, medical outcome information, and so forth) with CCDA information. The proprietary medical information and CCDA information exist as primarily unique data that are not merged. The networked environment 1400 also increases the safety of providing medical services to patients. For example, the networked environment 1400 enables a user to enter selection criteria to find (and filter) patients possessing the specified criteria. The networked environments allows the filtered list of patients to be combined with outcome data (e.g., juxtaposed to each other) to enable views to determine medical hypotheses. For example, a user can search for patients that regularly take albuterol (a medication) and search for patients that have a medical diagnosis of diabetes. In response, the system provides a filtered list of patients that take albuterol and have diabetes. Additionally, the system also provides outcomes data for the patients included in this filtered list (e.g., information indicative of an outcome of talking albuterol). By viewing the outcomes data with the filtered search results, a user is presented with relevant information that may assist the user in determining hypotheses (e.g., how albuterol affects diabetes).

Networked environment 1400 includes medical instrument system 1404, client device 1406, network 1408, CCDA system 1410, ASC system 1414, VPN 1416, hospital device (e.g., emergency room device) 1418 and data repository 1420. In this example, medical instrument system 1404 comprises a system for storing various medical instruments (e.g., medical questionnaires) and collecting patient responses to the medical instruments. The medical instrument system 1404 also stores information indicative of patient satisfaction scores (e.g., when medical instruments pertain to satisfaction) and outcome date and outcome scores (e.g., when the medical instruments pertain to outcomes of medical procedures). In an example, the medical instrument system 1404 is further described in U.S. Pat. Nos. 8,429,547 and 8,630,870, the entire contents of each of which are hereby incorporated by reference. In this example, medical instrument system 1404 sends, over network 1408, medical information 1422 to ASC system 1414. In this example, medical information 1422 includes information indicative of answers and other data collected through medical instruments 1405. In this example, medical information 1422 includes the name of the name or other information (e.g., a unique identified) that uniquely identifies the patient.

ASC system 1414 includes a system for triaging the intake of a patient, e.g., by obtaining signatures for consent forms and waivers and by reconciling conflicting data (e.g., conflicts between data obtained from a CCDA system and medical information 1422). The ASC system 1414 also allows uses to electronically request and receive data, e.g., from CCDA system and from medical instrument system 1404. The ASC system 1414 also complies with ASC rules that a physician can all patient information (e.g., whether it is from the medical instrument system 1404 or from the CCDA system 1410) but that staff are restricting in viewing of certain types of data. The ASC system 1414 implements these rules via ASC rules 1424 (which are stored in data repository 1420). In an example, the ASC rules 1424 specify which portions of user data are viewable to which medical personnel, e.g., by specifying user IDs for various portion of the user data. Then, when a particular user goes to view data, ASC system 1414 executes the ASC rules 1424 to determine whether the user is associated with an authenticated user ID for viewing of the data.

Networked environment 1400 also includes CCDA system 1410 for sending (e.g., via a HL7 feed) a CCDA record 1412 to ASC system 1414. The CCDA system 1410 is associated with a medical clinic or medical facility for a patient. Using the techniques described herein, the ASC system 1414 is configured to request the CCDA record.

In this example, ASC system 1414 stores CCDA record 1412 and medical information 1422 as two separate data sets. ASC system 1414 associates the two separate data sets with each other by determining a matching identifier (e.g., a patient name, a patient unique identifier, and so forth) among the data sets and generates a pointer. The ASC system 1414 also determines whether there is any conflicting information among the data sets (e.g., the same data field with differing data values). Upon detection of a conflict, the ASC system 1414 prompts a user to enter information to resolve the conflict, as previously described.

Networked environment 1400 also includes ER device 1418 (e.g., a device in an emergency room or in a hospital) that is configured for communication with ASC system 1414 via VPN 1416. In this example, ASC system 1414 receives real-time ER information 1426 from ER device 1418 over VPN 1416. As previously described, the real-time ER information 1426 enables the ASC system 1414 to display to a view the real-time monitoring results during a medical procedure and also enable the ASC system 1414 to notify and alert users of predefined events (e.g., a monitored value exceeds a threshold value) in real-time and over a non-private network (e.g., network 1408). This provides a viewer with access to ER information. In this example, data repository 1420 also stores information indicative of pre-defined alerts and triggers and rules specifying one or more devices and users to alert, e.g., upon detection of a triggering event. In this example, upon detection of a triggering event, the ASC system 1414 sends to client device 1406 a notification message to alert a user of client device 1406 of the triggering event.

The ASC system 1414 also associates the real-time ER information 1426 with the CCDA record 1412, for a particular patient, and with medical information 1422 for a particular patient. The ASC system 1414 does this detecting a match among identifying information (e.g., a patient name, a patient identifier, and so forth) in the CCDA record 1412, the medical information 1422 and the real-time ER information. In an example, ASC system 1414 collects thousands and millions of items of medical information 1422 from medical instrument system 1404 and thousands and millions of CCDA records from CCDA system 1410. Therefore, the memory and processing devices in ASC system 1414 are able to efficiently buffer, process and parse these millions of medical records to quickly generate the necessary associations between them. In the example of FIG. 14, ASC system 1414 generates data for graphical user interface 1402 that presents a side-by-side view of outcomes data (e.g., from medical information 1422) and CCDA data 1412.

In this example, a patient schedules an appoint for a medical procedure with ASC 1403. ER device 1418 is located inside ASC 1403. The request for the appointment may come from within another medical facility (e.g., CCDA system). When the other medical facility submits the request and schedules the outpatient surgery with the ASC 1403, the other medical facility submits the patient's medical records (e.g., CCDA record 1412) to ASC system 1414. Through this submission, ASC system 1414 promotes closing the gap of the surgery center when the patient is admitted.

Additionally, as previously described, ASC system 1414 performs reconciliation mitigation to ensure that the data (e.g., the CCDA data and the medical information) is synchronous and non-conflicting. Additionally, ASC system 1414 allows for real-time feedback that is secure, encrypted and HIPPA compliant, e.g., by the editing of the medical notes and by receiving the real-time ER information 1426 from ER device 1418. Additionally, when a triggering event is detected, ASC system alerts all users (e.g., doctors, nurses, and so forth) of the triggering event. The ASC system 1414 is also customizable in that a user can specify which types of information they want to view in a customizable report. The user can also define which events are triggering events (e.g., when a patient's blood pressure exceeds a threshold value).

In an example, data repository 1420 also stores notification rules 1425, e.g., information specifying when to contact users and how to contact users. In an example, ER device 1418 sends to ASC system 1414 monitoring information (e.g., blood pressure information). In this example, notification rules 1425 includes a rule then when blood pressure information exceeds a threshold value to alert the patient's mother, father and best friend, in addition to alerting the treating physician. A device of the treating physician made be connected to VPN 1416. As such the treating physician may be able to receive the notification over the VPN 1416. However, the devices of the mother, father and best friend are not connected to the VPN 1416 of the ER and/or of ASC 1403. Accordingly, the transmission of the real-time ER information 1426 over VPN 1416 to ASC system 1414 allows the ASC system 1414 to store the real-time ER information in the cloud (e.g., in data repository 1420) and to notify family members and friends, who are otherwise unable to be notified due to their lack of connectivity to the VPN 1416.

In an example, ASC system 1414 is located outside of ASC 1403. In another example, ASC system 1414 is located inside of ASC 1403. In a variation, ASC system 1414 includes medical instrument system 1404.

In an example, ASC system 1414 transforms the CCDA record 1412 and medical information 1422 into an ASC electronic medical record (e.g., an ASC EMR 1413). ASC system 1414 performs the transformation by generating a new data record for the patient. This new data record includes demographic information that is obtained from medical information 1422 and/or is obtained from a system input. The data record also includes outcomes information, satisfaction information and answers to medical instruments, as included in medical information 1422. The reconciliation process updates conflicting information in either CCDA record 1412 or in medical information 1422, such that information is reconciled. ASC system 1414 completes the transformation by attaching the CCDA record 1412 (e.g., with reconciled data) to the newly generated records. As previously described, data is reconciled by prompting a user to enter valid information (e.g., for a particular data field with conflicting values) and updating the data field with the entered information. ASC system 1414 performs the attachment by generating a database pointer from the CCDA record 1412 to the medical information 1422. Additionally, federal and/or various state governments may regulate ASC EMRs, e.g., by precluding them from including certain types of information, by requiring that information be encrypted according to specified formats, by requiring that the information be HIPPA compliant, by requiring that certain types of information be “scrubbed” to remove identifying information, as shown in the below Table 2:

TABLE 2

| Federal Regulation | Rule |
|---|---|
| Electronic health records | Enable drug-drug and drug-allergy checks on |
| (EHR) meet required | EMR |
| measures regarding | |
| Drug-drug and Drug-allergy | |
| Checks | |
| Electronic health records | Record patient diagnoses for more than 80% |
| (EHR) meet required | of patients |
| objectives regarding | |
| Problem List | |
| Medication Allergy List | Record patient medications for more than |
| | 80% |
| Electronic Exchange I | Provider send a summary of care record for |
| | more than 50% of transitions of care and |
| | referrals |
| Electronic Exchange II | A provider electronically transmit a summary |
| | of care for more than 10% of transitions of |
| | care and referrals |

As shown in the above Table 2, federal regulations have many requirements, e.g., EMRs (or EHRs) must enable drug-drug and drug-allergy checks, EMRs must record patient diagnoses for more than 80% of patients, and so forth. In this example, ASC system 1414 transforms the resulting ASC EMR by executing a rules engine that includes thousands of rules (such as the ones shown in the above Table 2) against the resultant ASC EMRs (e.g., thousands of ASC EMRs). For example, ASC system 1414 determines whether the resultant ASC EMRs record patient diagnoses for more than 80% of patients (e.g., 80% of the generated ASC EMRs). If the ASC system 1414 determines that the rule is satisfied, ASC system 1414 moves on to analysis of the next rule. When the ASC system 1414 determines that the rule is not satisfied, the ASC system updates the underlying data records for the ASC EMRs with the required information (e.g., update additional ASC EMRs with patient diagnosis information).

Other federal regulations mandate the actual use cases of electronic information exchange. In this example, a rule requires that a provider send a summary of care record for more than 50% of transitions of care and referrals and another rules requires that the provider electronically transmit a summary of care for more than 10% of transitions of care and referrals. In this example, the ASC system 1414 also executes these electronic exchange rules and if it determines that a requirement is not satisfied generates the required electronic exchanges (e.g., generates a summary of care record and sends to a patient or medical provider). Generally, the regulations for ASC EMRs differ from those for EMRs generally, given the different nature of ASCs—which prevent overnight stays. Therefore, an ASC EMR is different from other EMRs (e.g., EMRs for a hospital or an emergency room) because the ASC EMR may only include information for the ASC in combination with other CCDA information and perhaps other health care information for a patient. In still another example, given the different government regulations, the ASC EMR is separate and distinct from other types of EMRs that are regulated by different, other government rules. By generating an ASC EMR, ASC system enhances patient safety and quality outcomes. The ASC EMR provides extensive amounts of clinical data that reveal trends and outcomes easily missed in paper charts. An ASC EMR also greatly reduces errors by standardizing processes, while electronic flags and alerts warn staff of missing steps and other factors that could possibly harm the patient. An ASC EMR also benefits patients after they have left the ASC. An ASC EMR ensures that at the time the patient is discharged, all their records are complete and timely. The ASC also increases operating room (OR) efficiency, because the charts (such as those previously shown) are right in front of the surgical team; they're able to chart quickly, efficiently and everyone is able to read it.

EMR in a surgery center is very different from EMR in a physician's office. Since there are only a limited number of operations performed, steps like diagnosis and treatment, which are necessary for EMRs to track in physicians' offices, may not be included an ASC based EMR. However, ASC system 1414 is able to integrate data records from numerous different sources with real-time OR information (received over the private network) to generate a very powerful ASC EMR 1413, e.g., based on the template based integration. Accordingly, integration with the CCDA record 1412 and the other medical information 1422 provides for a very comprehensive ASC EMR 1413, e.g., an ASC EMR that includes diagnosis and treatment as specified in either CCDA record 1412 or medical information 1422. An ASC-based EMR follows the process from pre-op through surgery and post-op, making sure safety and compliance requirements are met. Additionally, the ASC system 1414 is able to achieve a high level of interoperability. It is difficult to send information electronically from one EMR system to another, whether the system is in a hospital, physician's office or ASC. Even when both sender and receiver have an EMR, information often must be faxed. For example, the physician's office faxes the patient's history and physical to the ASC. In an example, this document is scanned into ASC system 1414 and displayed as a PDF-style page. In another example, ASC system 1414 is configured for electronic communication with CCDA system 1410, e.g., to enable ASC system 1414 to electronically obtain CCDA record 1412. In this example, ASC system 1414 is able to integrate CCDA record 1412 with medical information 1422 and with ASC-specific information (e.g., real-time ER information 1426). In this example, CCDA system 1410 may be an EMR system.

In this example, ASC system 1414 is able to do the electronic integration via a data feed into CCDA system 1410. ASC system 1414 also includes a template for converting information in the CCDA record 1412 to a format of the medical information 1422 and/or to a format of the ASC EMR, as described in U.S. Ser. No. 12/774,694, the entire contents of which are incorporated herein by reference. One of the difficulties of EMR integration is that every EMR has different fields and format that it uses for the storage of data. The template described in U.S. Ser. No. 12/774,694 provides for EMR integration by pre-mapping fields in one type of EMR to fields in another EMR, in advance of run-time integration. For example, if ASC system is to be interoperable with a CCDA system 1410 (or another EMR system), the ASC system 1414 will generate template that provides a mapping between the field in the EMR for the other EMR system and the fields in the ASC EMR 1413, e.g., thereby enabling ASC system 1414 to import the information into the ASC EMR 1413. This template can also be used for converting the medical information 1422 into a format of ASC EMR 1413, thereby integrating the medical records from different data sources and EMRs. The ASC EMR may include ASC specific fields for pre-op information, surgery information and post-op information. ASC system 1414 populates these fields of the ASC EMR 1413 with information obtained from the OR device in the ASC. The ASC EMR 1413 may also include other fields that are unrelated to the ASC, e.g., treatment and diagnosis fields. In this example, the template specifies which fields in the CCDA record 1412 or in the medical instrument data correspond to the treatment and diagnosis fields in the ASC EMR 1413. Upon retrieving the CCDA record 1412 or the medical instrument data 1404, the ASC system 1414 identifies the treatment and diagnosis fields in the CCDA record 1412 or the medical instrument data 1404 and selects the information included in those fields. The ASC system 1414 then populates the treatment and diagnosis fields in the ASC EMR 1413 template with the selected information, e.g., by updating fields in underlying database records with the selected information. By integrating the CCDA record 1412 and other EMR information with the ASC EMR 1413, the ASC EMR 1413 is able to provide surgeons and other medical personnel in the ASC with a comprehensive view of the medical history of a patient and with side-by-side analysis of OR data in comparison to outcomes, satisfaction, treatment and diagnosis. That is, ASC system 1414 is able to provide ASC personnel (such as surgeons) with a real-time view of the patient's health. This ASC EMR 1413 ensures compliance by helping ASC quickly and easily access all information requested during accreditation, state and CMS surveys. The ASC EMR 1413 also helps with clinical reporting and quality outcome requirements, e.g., by storing safe surgery checklists and by prompting team members to checking off specific items on the checklist.

In an example, ASC EMR 1413 includes a specified format. In this example, using the template, ASC system 1414 converts the CCDA record 1412, the medical information 1422 (that includes outcome information and satisfaction information), and real-time ER information 1426 into the format of ASC EMR 1413 to provide for an integrated ASC EMR 1413. The ASC EMR 1413 is transmittable to numerous devices to promote continuity of care, e.g., transmitting to a physician's office.

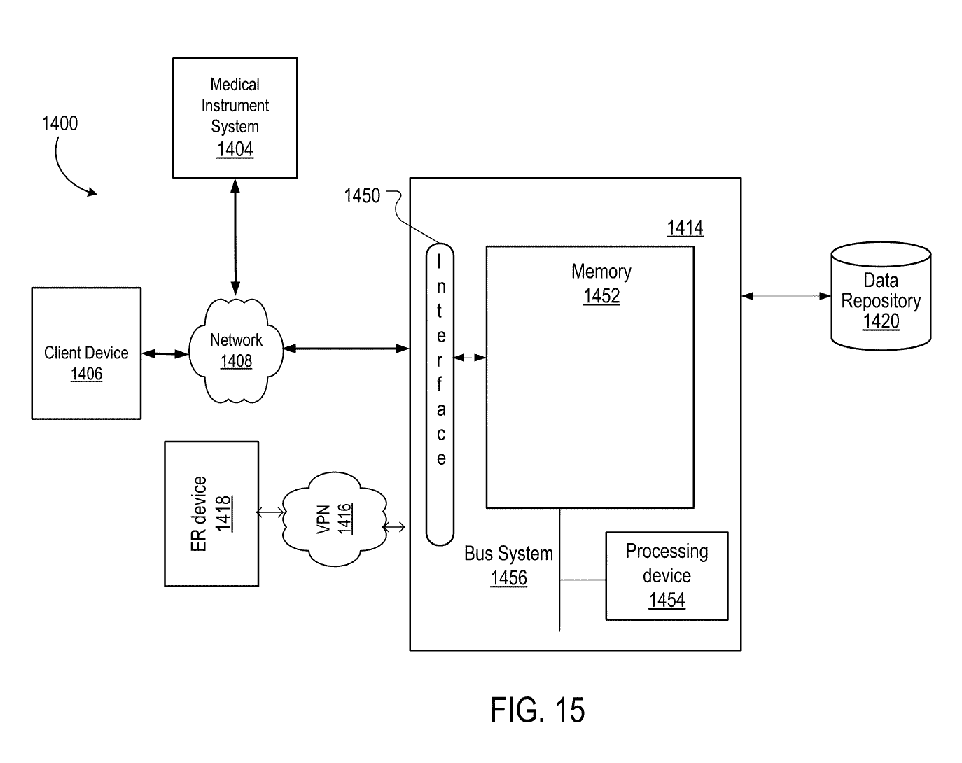

Referring to FIG. 15, client device 1406 and medical instrument system 1404 can be any sort of computing devices capable of taking input from a user and communicating over network 1408 with system 1414 and/or with other client devices. For example, client device 1406 and medical instrument system 1404 can be mobile devices, desktop computers, laptops, cell phones, personal digital assistants (“PDAs”), servers, embedded computing systems, and so forth.

System 1414 can be any of a variety of computing devices capable of receiving data, such as a server, a distributed computing system, a desktop computer, a laptop, a cell phone, a rack-mounted server, and so forth. System 1414 may be a single server or a group of servers that are at a same location or at different locations.

The illustrated system 1414 can receive data from client device 1406, medical instrument system 1404 and ER device 1418 via input/output (“I/O”) interface 1450. I/O interface 1450 can be any type of interface capable of receiving data over a network, such as an Ethernet interface, a wireless networking interface, a fiber-optic networking interface, a modem, and so forth. System 1414 also includes a processing device 1454 and memory 1452. A bus system 1456, including, for example, a data bus and a motherboard, can be used to establish and to control data communication between the components of system 1414.

The illustrated processing device 1454 may include one or more microprocessors. Generally, processing device 1454 may include any appropriate processor and/or logic that is capable of receiving and storing data, and of communicating over a network (not shown). Memory 1452 can include a hard drive and a random access memory storage device, such as a dynamic random access memory, or other types of non-transitory machine-readable storage devices. Memory 1452 stores computer programs (not shown) that are executable by processing device 1454 to perform the techniques described herein.

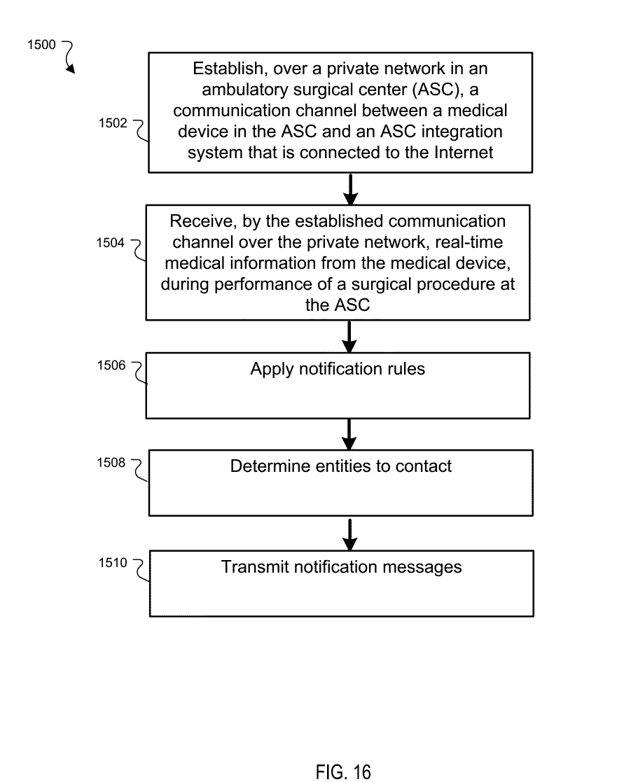

Referring to FIG. 16, ASC system 1414 performs process 1500 in transmitting OR information to individuals outside of the OR, in a secure, encrypted, HIPPA-compliant manner. In operation, ASC system 1414 establishes (1502), over a private network in an ambulatory surgical center (ASC), a communication channel between a medical device in the ASC and an ASC integration system that is connected to the Internet, with the medical device being restricted to communication over the private network. ASC system 1414 receives (1504), by the established communication channel over the private network, real-time medical information from the medical device, during performance of a surgical procedure at the ASC. ASC system 1414 applies (1506) one or more notification rules to the received real-time medical information to detect the occurrence of a triggering event. ASC system 1414 determines (1508), from the one or more notification rules, one or more entities to contact regarding the triggering event, with the one or more entities having one or more devices that are unconnected to the private network. ASC system 1414 transmits (1510), over the Internet, one or more notification messages to the one or more devices that are unconnected to the private network.

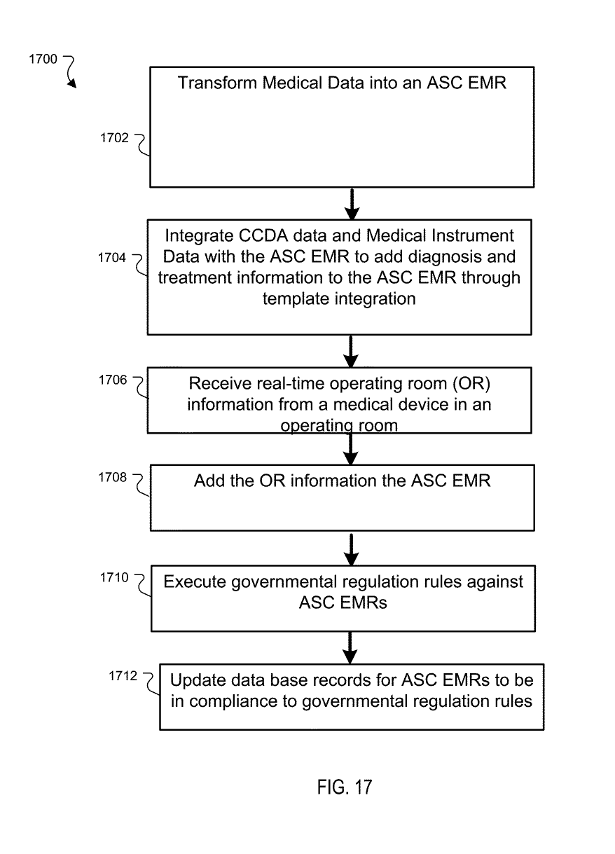

Referring to FIG. 17, ASC system 1414 performs process 1700 in transforming collected medical data into an ASC EMR, e.g., by updating and writing to underlying database records in a defined manner. In operation, ASC system 1414 transforms (1702) medical data into an ASC EMR by receiving, from an external device (e.g., at another EMR system, at a hospital, and so forth), a Consolidated Clinical Document Architecture (CCDA) record that includes first medical information for a patient for whom the surgical procedure is being scheduled. ASC system 1414 also receiving, from another external device (e.g., the medical instrument system), second medical information for the patient. ASC system 1414 detects a conflict between the first medical information and the second medical information; and prompts a user for information to resolve the conflict.

ASC system 1414 also transforms (1702) the first and second medical information into an ASC EMR by generating a data record that includes the second medical information and attaching the generated data record to the first medical record. ASC system 1414 integrates (1704) the CCDA data and Medical Instrument Data with the ASC EMR to add diagnosis and treatment information to the ASC EMR through template integration, as previously described. ASC system 1414 receives (1706), from an electronic device in an operating room over a private network, real-time operating room information. ASC system 1414 adds (1708) the real-time operating room information to the ASC EMR. ASC system 1414 executes (1710) a rules engine against contents of ASC EMRs (e.g., millions of ASC EMRs) to determine whether the ASC EMRs comply with one or more governmental regulations for ASC EMRs. ASC system 1414 updates (1712) data base records for ASC EMRs to be in compliance to governmental regulation rules, as previously described.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be information in different formats such as text, graphics, images, sound, video, Hypertext Markup Language (HTML), as well as programs. Upon specification of a link by the user, the client computer makes a TCP/IP request to a Web server and receives information, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Sun, Linux, and Macintosh may also be used. Computer users can view information available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A computer-implemented method comprises:
establishing, over a private network in an ambulatory surgical center (ASC), a communication channel between a medical device in the ASC and an ASC integration system that is connected to the Internet, with the medical device being restricted to communication over the private network;
receiving, by the established communication channel over the private network, real-time medical information from the medical device, during performance of a surgical procedure at the ASC;
applying one or more notification rules to the received real-time medical information to detect the occurrence of a triggering event;
determining, from the one or more notification rules, one or more entities to contact regarding the triggering event, with the one or more entities having one or more devices that are unconnected to the private network; and
transmitting, by the ASC system over the Internet, one or more notification messages to the one or more devices that are unconnected to the private network.

2. The computer-implemented method of claim 1, further comprising:
receiving, from an external device, a request to schedule the surgical procedure with the ASC;
receiving, from the external device, a Consolidated Clinical Document Architecture (CCDA) record that includes first medical information for a patient for whom the surgical procedure is being scheduled;
receiving, from another external device, second medical information for the patient;
detecting a conflict between the first medical information and the second medical information; and
prompting a user for information to resolve the conflict.

3. The computer-implemented method of claim 2, further comprising:
transforming the first and second medical information into an ASC EMR by generating a data record that includes the second medical information and attaching the generated data record to the first medical record;
executing a rules engine against contents of ASC EMRs to determine whether the ASC EMRs comply with one or more governmental regulations for ASC EMRs; and
receiving, from an electronic device in an operating room over a private network, real-time operating room information; and
adding the real-time operating room information to the ASC EMR.

4. The computer-implemented method of claim 2, wherein the second medical information is retrieved from a medical instrument system that is configured to administer one or medical instruments and collect results of those medical instruments.

5. The computer-implemented method of claim 1, further comprising:
generating information indicative of an appointment to perform the surgical procedure; and
defining, for the appointment, one or more roles of service providers in the ASC with regards to the surgical procedure, with a role specifying one or more types of information that a particular type of service provider is responsible for inputting into the ASC system.

6. The computer-implemented method of claim 4, further comprising:
receiving information that is input to the system from a service provider assigned to a specific role, with the received information including a personal identification number; and
confirming that the personal identification number matches an authorized personal identification number of a user who is authorized to perform the role and to input a type of information to be completed by an entity in the assigned role.

7. The computer-implemented method of claim 1, further comprising:
automatically triaging, by the ASC system, intake of a patient for whom the surgical procedure is performed by performing operations comprising:
generating data for a graphical user interface that displays consent forms and medical information for the patient, with the medical information being collected from a plurality of different data sources.

8. The computer-implemented method of claim 1, further comprising:
synchronizing, by the ASC system, the real-time medical information with other medical information included in a data repository of the ASC system.

9. The computer-implemented method of claim 7, wherein synchronizing comprises:
updating a data record in the data repository with the real-time medical information.

10. One or more machine-readable hardware storage devices storing instructions that are executable by one or more processing devices to perform operations comprising:
establishing, over a private network in an ambulatory surgical center (ASC), a communication channel between a medical device in the ASC and an ASC integration system that is connected to the Internet, with the medical device being restricted to communication over the private network;
receiving, by the established communication channel over the private network, real-time medical information from the medical device, during performance of a surgical procedure at the ASC;
applying one or more notification rules to the received real-time medical information to detect the occurrence of a triggering event;
determining, from the one or more notification rules, one or more entities to contact regarding the triggering event, with the one or more entities having one or more devices that are unconnected to the private network; and
transmitting, by the ASC system over the Internet, one or more notification messages to the one or more devices that are unconnected to the private network.

11. The one or more machine-readable hardware storage devices of claim 10, wherein the operations further comprise:
receiving, from an external device, a request to schedule the surgical procedure with the ASC;
receiving, from the external device, a Consolidated Clinical Document Architecture (CCDA) record that includes first medical information for a patient for whom the surgical procedure is being scheduled;
receiving, from another external device, second medical information for the patient;
detecting a conflict between the first medical information and the second medical information; and
prompting a user for information to resolve the conflict.

12. The one or more machine-readable hardware storage devices of claim 11, wherein the operations further comprise:
transforming the first and second medical information into an ASC EMR by generating a data record that includes the second medical information and attaching the generated data record to the first medical record;
executing a rules engine against contents of ASC EMRs to determine whether the ASC EMRs comply with one or more governmental regulations for ASC EMRs; and
receiving, from an electronic device in an operating room over a private network, real-time operating room information; and
adding the real-time operating room information to the ASC EMR.

13. The one or more machine-readable hardware storage devices of claim 11, wherein the second medical information is retrieved from a medical instrument system that is configured to administer one or medical instruments and collect results of those medical instruments.

14. The one or more machine-readable hardware storage devices of claim 10, wherein the operations further comprise:
generating information indicative of an appointment to perform the surgical procedure; and
defining, for the appointment, one or more roles of service providers in the ASC with regards to the surgical procedure, with a role specifying one or more types of information that a particular type of service provider is responsible for inputting into the ASC system.

15. The one or more machine-readable hardware storage devices of claim 14, wherein the operations further comprise:
receiving information that is input to the system from a service provider assigned to a specific role, with the received information including a personal identification number; and
confirming that the personal identification number matches an authorized personal identification number of a user who is authorized to perform the role and to input a type of information to be completed by an entity in the assigned role.

16. The one or more machine-readable hardware storage devices of claim 10, wherein the operations further comprise:
automatically triaging, by the ASC system, intake of a patient for whom the surgical procedure is performed by performing operations comprising:
generating data for a graphical user interface that displays consent forms and medical information for the patient, with the medical information being collected from a plurality of different data sources.

17. The one or more machine-readable hardware storage devices of claim 10, wherein the operations further comprise:
synchronizing, by the ASC system, the real-time medical information with other medical information included in a data repository of the ASC system.

18. The one or more machine-readable hardware storage devices of claim 17, wherein synchronizing comprises:
updating a data record in the data repository with the real-time medical information.

19. An electronic system comprising:
one or more processing devices; and
one or more machine-readable hardware storage devices storing instructions that are executable by one or more processing devices to perform operations comprising:
establishing, over a private network in an ambulatory surgical center (ASC), a communication channel between a medical device in the ASC and an ASC integration system that is connected to the Internet, with the medical device being restricted to communication over the private network;
receiving, by the established communication channel over the private network, real-time medical information from the medical device, during performance of a surgical procedure at the ASC;
applying one or more notification rules to the received real-time medical information to detect the occurrence of a triggering event;
determining, from the one or more notification rules, one or more entities to contact regarding the triggering event, with the one or more entities having one or more devices that are unconnected to the private network; and
transmitting, by the ASC system over the Internet, one or more notification messages to the one or more devices that are unconnected to the private network.
